(19) United States
(12) Patent Application Publication
(10) Pub. No.: US 2005/0175059 A1
(43) Pub. Date: Aug. 11, 2005

(54) Feedback stabilized multimode and method of stabilizing a multimode laser

(75) Inventors: Lance Leclair, Manassas, VA (US); Nigel Holehouse, St-Lazare (CA); Richard Murison, St-Lazare (CA)

Correspondence Address: William L. Botjer, PO Box 478, Center Moriches, NY, 11934, US

(73) Assignee: ALFA-LIGHT, INC.

(21) Appl. No.: 10/970,943

(22) Filed: Oct. 22, 2004

Related U.S. Application Data
(63) Continuation of application No. PCT/CA03/00589, filed on Apr. 23, 2003.
(60) Provisional application No. 60/375,261, filed on Apr. 24, 2002.

(51) Int. Cl. H01S 3/08

(52) U.S. Cl. 372/102; 372/92; 372/32

(57) ABSTRACT

A laser assembly (10) comprises a multimode laser (12) having at least one output and operating at a given wavelength. It also includes a double-clad optical fiber (20) having a free end (22) coupled to the output of the laser (12). The optical fiber (20) comprises a core (24) in registry with the output of the laser (12), a multimode inner cladding (26) surrounding the core (24), and an outer cladding (28) surrounding the inner cladding (26), the outer cladding (28) being provided to contain light in the inner cladding (26). A fiber Bragg grating (30) is written in the core (24) of the fiber (20) at a given distance from the free end (22) thereof. The Bragg grating (30) has a reflection spectrum within the gain spectrum of the laser (12). In use, it generates a sufficient feedback and stabilizes the laser (12) at the reflection spectrum of the Bragg grating (30). This provides a low cost laser assembly that is simple, suitable for volume manufacturing and small in size.

### CROSS REFERENCE TO RELATED APPLICATIONS

This application is a continuation of, and claims priority of PCT application PCT/CA03/00589 filed Apr. 23, 2003 which in turn claims priority of U.S. provisional application No. 60/375,261 filed Apr. 24, 2002.

### BACKGROUND OF THE INVENTION

Multimode (MM) semiconductors lasers, for instance MM diode lasers, are generally less costly than single mode lasers in terms of Dollars per delivered Watt of optical power and they can deliver much higher power. However, MM lasers are generally not always suitable for use in applications requiring precise emission spectra, for instance in applications where they are used as pump sources, essentially because of problems with line width and center wavelength stability. MM lasers are more typically found in devices for cutting materials or engraving, although they can be used as a gain source to optically pump another medium that is to be used as a laser or an optical amplifier.

One drawback of using a MM laser as a gain source to optically pump another medium is that the spectral bandwidth of MM lasers is often wider than the absorption spectrum of the medium. Thus, the fraction of the laser's output that falls outside of the pump absorption band is wasted. It is therefore desirable that the operating bandwidth of MM lasers be less than or equal to the absorption bandwidth of the absorbing medium and also held controllably within that absorption spectrum so that the pumping process can be made considerably more effective. For example, ErYb-doped systems have a very broad absorption region around 915 nm, and so can be pumped effectively by regular MM lasers. On the other hand Nd:YAG systems are often pumped at 808 nm, an absorption band that is narrower than most MM lasers.

Another known problem with MM lasers is that the average center wavelength of their emission spectrum is strongly dependent on temperature. When a MM laser is used as a pump source, its center wavelength is typically maintained at the peak-absorbing wavelength of the pumped medium by controlling the temperature thereof. This is usually accomplished by attaching the MM laser to a thermoelectric cooler (TEC) with a closed loop temperature control circuit. However, a TEC adds costs, complexity, and additional excess heat to be dissipated. It is thus unsuitable for deployment in many applications. It can also place limits on the operating temperature range of the resulting assembly.

In view of the above, there was thus a need to stabilize the optical emission spectrum of MM lasers using a low cost assembly that is simple, robust, suitable for volume manufacturing and small in size. Such assembly can be used in a wide range of applications, particularly for telecommunications.

### SUMMARY OF THE INVENTION

Briefly stated, the new arrangement that is hereby proposed by the present invention consists of a MM laser coupled to a double-clad MM optical fiber containing a Bragg grating reflector written into the core.

In accordance with one aspect of the present invention, the laser assembly comprises a multimode laser provided with at least one output, the laser operating at a given wavelength and having a gain spectrum. It also includes a double-clad step-index optical fiber having a free end coupled to the output of the laser. The double-clad optical fiber comprises a core, a multimode inner cladding surrounding the core, and an outer cladding surrounding the inner cladding, the outer cladding being provided to contain light in the inner cladding. Means are provided for coupling the output of multimode laser into the optical fiber so that a significant portion of the output be coupled into the core of the double-clad optical fiber. The assembly is characterized in that a Bragg grating is written in the core of the double-clad optical fiber at a given distance from the free end thereof. The Bragg grating has a reflection spectrum within the gain spectrum of the laser, generates a sufficient feedback and thereby stabilizes the laser at the reflection spectrum of the Bragg grating.

Another aspect of the present invention is to provide a method of stabilizing a multimode laser having at least one output and operating at a given wavelength. In this method, a double-clad step index optical fiber is coupled to the output of the laser. This double-clad optical fiber has a core, a multimode inner cladding surrounding the core, and an outer cladding surrounding the inner cladding, the outer cladding being provided to contain light in the inner cladding. The free end of the double-clad optical fiber is positioned so that some of the light emitted by the multimode laser enters the core thereof while most of the remainder enters the inner cladding. The method is characterized in that a Bragg grating is written in the core of the double-clad optical fiber at a given distance from the free end thereof. The Bragg grating has a reflection spectrum within the gain spectrum of the laser. The double-clad optical fiber has a free end that is positioned or coupled by an optical means so that some of the light emitted by the laser enters the core thereof. In use, when light is emitted at the laser, at least some of the light traveling in the core is reflected backwards by the Bragg grating and reenters into the laser so as to generate a sufficient feedback to stabilize it at the reflection spectrum of the Bragg grating.

### BRIEF DESCRIPTION OF THE DRAWINGS

Various other aspects and advantages of the present invention are disclosed in the following detailed description. This detailed description makes reference to the appended figures in which:

FIG. 1 is a schematic view of an example of a laser assembly according to the preferred embodiment of the present invention.

FIG. 2 is a graph showing an example of the optical spectra taken from the output of a double-clad optical fiber, one curve being without the fiber Bragg grating (FBG) and the other being with the FBG.

FIG. 3 is a graph showing an example of the central wavelength as a function of temperature, one curve being without the FBG and the other being with the FBG.

### DESCRIPTION OF THE PREFERRED EMBODIMENTS

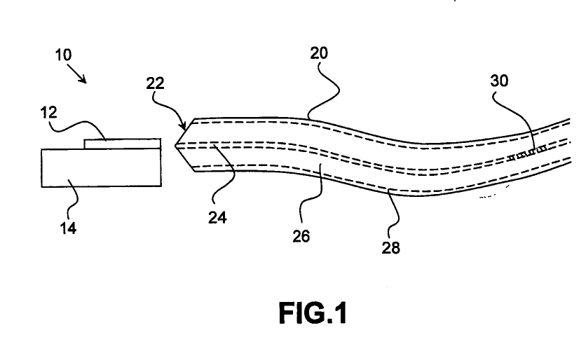

FIG. 1 schematically shows an example of a laser assembly (10) in accordance with the preferred embodiment of the present invention. It should be understood that the present invention is not limited to this precise embodiment and that various changes and modifications may be effected therein without departing from the scope of the present invention, as defined by the appended claims.

In FIG. 1, the laser assembly (10) comprises a multimode (MM) laser (12), for instance a laser diode chip with a single output, mounted on a chip carrier (14). The MM laser (12) is coupled to a double-clad MM optical fiber (20) provided with a wedge-shaped lens (22) at the free end thereof. The center of the lens (22) coincides with the core of the double clad fiber and is in registry with the output of the MM laser (12). It should be noted that the laser assembly (10) can have a MM laser (12) with more than one output. Alternatively, one can use a plurality of laser diode chips, each with one or more outputs. This will require the use of collimating optics (not shown). Moreover, it is possible to use an individual lens (not shown) for coupling the tip of the MM optical fiber (20) to the output of the laser (12), although this introduces more surfaces and increases mechanical assembly complexity.

The MM optical fiber (20) is preferably a so-called “double clad” step index fiber. It comprises a core (24), an inner cladding (26) that is much larger in diameter than that of the core (24) and propagates light in many modes, and an outer cladding (28) that serves to contain the inner cladding light by total internal reflection. In this preferred embodiment, the core (24) is capable of propagating a single mode in the wavelength range at which the MM laser (12) operates.

A fiber Bragg grating (30) with sufficient reflection strength is written in the core (24) of the MM optical fiber (20) at a given distance from the free end thereof. A fiber Bragg grating is a modulation of the index of refraction in the light guiding section of an optical fiber waveguide, typically in a longitudinal direction. When this modulation is set up with a constant period near the wavelength of light, the light traveling through such a grating at a specific wavelength creates multiple back reflections that are in phase and constructively interfere with one another. The result is that light with that specific wavelength (equal to twice the period of the Bragg grating times the index of refraction of the waveguide), is back-reflected while light at other wavelengths passes through unchanged.

In the case of a single mode laser, for instance a laser diode, coupled to a single mode fiber, the emitted light is confined to the optical fiber core and travels along one and only one path through the core. Thus, when encountering a fiber Bragg grating, the forward propagating light is at normal incidence to the fiber Bragg grating. The backward propagating light created by the grating remains confined to the core, normal to the grating, and retraces its path all the way back to the laser. When the fiber Bragg grating has sufficient strength, but not too much (otherwise light would not propagate pass the grating), and the coupling efficiency of the optical fiber to the laser is sufficient, the reflected light creates the desired feedback. This forces the laser to oscillate with an output spectrum that matches the reflection spectrum of the Bragg grating. The reflection strength of the Bragg grating is usually between 1 and 5%. This is effect is well known and described in previous U.S. Pat. Nos. 5,485,481, 5,563,732, 5,715,263, and 6,044,093.

Unlike single mode lasers, MM lasers are usually coupled to MM optical fibers because they cannot be coupled efficiently to a single mode fiber. Light traveling in the core of a MM optical fiber can take multiple paths through the inner cladding, provided that the angle of these paths does not exceed the critical angle for total internal reflection from the outer cladding. If a fiber Bragg grating is embedded within the inner cladding of a MM optical fiber, the rays of light could intersect the fiber Bragg grating at many angles other than the normal. Because the reflection wavelength depends strongly on the incident angle of the rays, this would result in the grating of a MM optical fiber having a very much broader reflection spectrum than a grating of the same nominal design in a single mode fiber. One way to solve this problem is to reduce the angle of divergence of the rays with a lens, such as described in U.S. Pat. No. 6,356,574. This problem is solved in the present invention by using the double-clad step index fiber.

As shown in FIG. 1, the fiber (20) is coupled to the MM laser (12), so that that a significant amount of light (more than 0.5%) is coupled into the core (24). The reflection from the fiber Bragg grating (30) forces the MM laser (12) to lock to the same optical spectrum as the fiber Bragg grating (30), as long as the fiber Bragg grating spectrum lies within the gain spectrum of the MM laser (12). It then remains locked even when the laser temperature varies over a modest range. It was found that with the MM laser (12), the feedback from the core (24) entirely changes the modal structure thereof. The result is that even the light launched into the MM inner cladding (26) is controlled by the wavelength of the fiber Bragg grating (30).

Preferably, the core (24) of the MM optical fiber (20) is germanium-doped and, as aforesaid, made small enough to propagate only a single mode in the operating wavelength range of the MM laser (12). Using an MM core would be possible as well for some applications. The MM inner cladding (26) is preferably made from pure silica. The outer cladding (28) is preferably made from fluorine-doped silica. Although both the core (24) and the inner cladding (26) propagate the light coupled from the MM laser (12) into the MM optical fiber (20), most of power is carried by the MM inner cladding (26). The fiber Bragg grating (30) is preferably written into the core (24) using standard holographic UV exposure techniques (described in textbooks by Othonos & Kali, Fiber Bragg Grating: Fundamentals and Applications in Telecommunications and Sensing, Artech House, 1999; and Kashyap, Fiber Bragg Gratings, Academic Press, 1^{st} edition, 1999). The fiber Bragg grating (30) is confined to the core (24) due to the well-known fact that the grating is more strongly written in Ge-doped silica than in pure silica, by orders of magnitude. While Ge-doped cores are preferred, other dopants or combinations thereof may be used.

In use, when the fiber (20) is properly coupled to the MM laser (12), such that sufficient power is coupled into the core (24), the desired feedback effect can be achieved and the MM laser output spectrum becomes controlled by, or “locked” to the fiber Bragg grating reflection spectrum. Because only a small fraction of the light coupled from the MM laser (12) propagates in the core (24), the fiber Bragg grating (30) that is written into it must have a very high reflectivity, preferably of about 10% or more. Due to the high reflectivity required, it may be necessary to hydrogen load the double-clad MM optical fiber (20) prior to the UV exposure. Other methods known to those skilled in the art could be used as well. There may also be some index of refraction modification to the fluorine-doped outer cladding (28). At worse, it could lead to some of the MM light in the inner cladding (26) leaking through the outer cladding (28).

### EXAMPLE

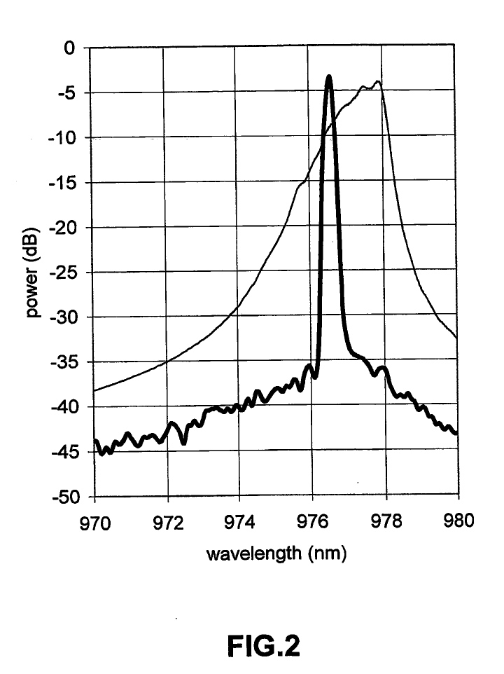

An experiment was conducted using a MM optical fiber having a fiber Bragg grating (FBG) with a reflectivity exceeding 99% written into a single-mode core. The double-clad optical fiber had a 5/90/125 micron diameter core/MM inner cladding/outer cladding, respectively, as described above. This optical fiber had a numerical aperture (NA) of 0.14 for the core/inner cladding interface, and NA of 0.22 for the inner cladding/outer cladding interface. The optical fiber had a length of about 1 meter, with the grating in this case situated 30 cm from a MM laser having a 980 nm wavelength. The end of the optical fiber presented to the output of the MM laser was shaped with a wedge with a 110 degree included angle (optimized for coupling into the multimode core), but the tip was modified with a second wedge that had an included angle of about 140 degrees (optimized for coupling into the single-mode core). Although this was probably not the best optimized lens combination for this sort of coupling, the desired effect was clearly demonstrated and the line narrowing was quite dramatic. FIG. 2 shows the optical spectra taken from the output of the double-clad optical fiber with (heavy line on the graph) and without (light line on the graph) the FBG in the core under identical conditions. The wavelength locking and line narrowing were both excellent with the FBG. The optical spectrum was reduced from wide structure spanning several nanometers to a single line with a full width at half maximum (FWHM) of 0.3 nm and a side-mode suppression ratio (SMSR) of greater than 30 dB over a range of 10° C. The total coupled power was slightly less than that coupled with the same wedge lens from the same laser into a regular MM optical fiber without a FBG.

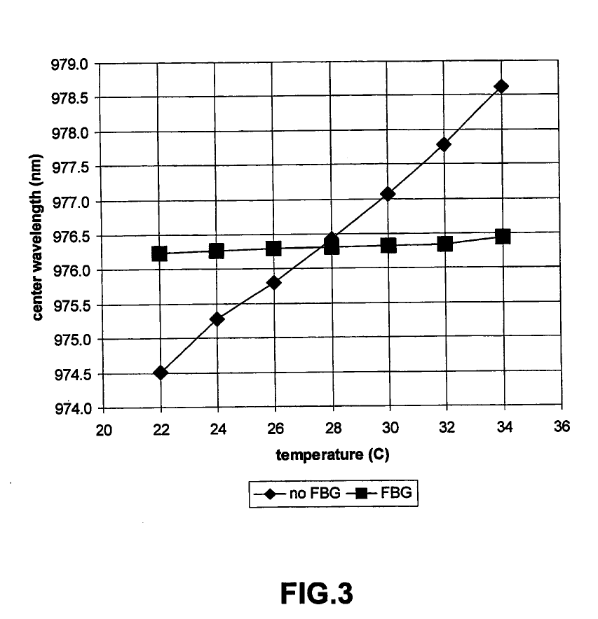

FIG. 3 demonstrates the wavelength stabilizing influence of the FBG on the MM diode laser in the same experiment. The data represented by the diamonds is the center wavelength of the emission spectrum of a diode laser as a function of temperature. As can be seen, the center wavelength changes by approximately 4 nm over the 12° C. temperature range, which is quite typical for laser diodes. The data represented by the squares was taken under identical circumstances, except a FBG was introduced in the core of the double-clad fiber. Now, the center wavelength change is only 0.2 nm over the same temperature range, a reduction in temperature sensitivity by a factor of 20.

Yet, in the same experiment, another mode of operation was observed, with similar effects as those described above, but attributed to a different interaction between the Bragg grating and the light propagating in the optical fiber. The inner cladding of the optical fiber supports a plurality of different modes, hence the term multimode. One of these modes is termed the fundamental mode, and is characterized by a single intensity peak centered in the middle of the inner cladding, and whose profile is invariant as it propagates along the optical fiber. This mode also interacts with the Bragg grating in the single-mode core, and produces a narrow-band reflection. However, this reflection is different from that encountered by light propagating within the single-mode core itself, in two significant ways. First, because the “effective propagating index” of the fundamental mode of the inner cladding is lower than that of the mode in the single-mode core, then the “wavelength” of the Bragg grating as seen by the former mode will be blue-shifted compared to that seen by the latter mode. Second, because a much smaller fraction of the former mode interacts with the Bragg grating as it propagates down the optical fiber, the reflectivity of the grating for that mode will be significantly smaller than for the latter mode, but this may be compensated for by the fact that the reflected mode will be spatially broad, and will therefore be expected to interact with more of the MM laser. Experimentally, under certain conditions, it was observed that the MM laser “locks” to this blue-shifted fundamental mode of the inner cladding. It may be the case that optimized conditions exist for operation in either locked mode. Further, this result suggests a variation upon the double-clad optical fiber described herein, wherein a means is established to form a Bragg grating at the center of an inner cladding, but which is limited in its transverse extent by some means other than the localized Ge-doping described herein, and which may not in itself comprise a single-mode core. For example, it may not be necessary to provide the core of the double-clad optical fiber as a single-mode core. One can design the core to be large enough to propagate several modes.

As with earlier patents that describe FBG stabilization of single mode lasers with FBG in single clad fibers (U.S. Pat. Nos. 5,485,481, 5,563,732, 5,715,263 and 6,044,093), it was observed that the given distance between the FBG and the MM laser is relevant. Those earlier patents stated the importance of placing the FBG beyond the coherence length of the laser (a length equal to about 0.5 mm for a MM laser with a spectral width of 2 nm). However, the FBG must not be placed to far away from the MM laser, otherwise micro stresses in the single mode core of the double clad optical fiber can change the state of polarization of the light propagating in the core so much that the backreflection does not match the linearly polarized light of the MM laser. When this occurs, the effect of the feedback is reduced and the MM laser does not “lock” very well to the grating.

As is well known the parameters set forth herein are for example only, such parameters can be adjusted in accordance with the teachings of this invention. The invention has been described with respect to preferred embodiments. However, as those skilled in the art will recognize, modifications and variations in the specific details which have been described and illustrated may be resorted to without departing from the spirit and scope of the invention as defined in the appended claims

1. A laser assembly comprising:
a multimode laser provided with at least one output, the multimode laser operating at a given wavelength and having a gain spectrum;
a double-clad step-index optical fiber having a free end coupled to the output of the multimode laser, the double-clad optical fiber comprising:
a core;
a multimode inner cladding surrounding the core; and
an outer cladding surrounding the inner cladding, the outer cladding being provided to contain light in the inner cladding; and
means for coupling the output of multimode laser into the optical fiber so that a significant portion of the output be coupled into the core of the double-clad optical fiber;
wherein the improvement comprises:
a fiber Bragg grating written in the core of the double-clad optical fiber at a given distance from the free end thereof, the Bragg grating having a reflection spectrum within the gain spectrum of the multimode laser for generating a sufficient feedback and thereby stabilizing the multimode laser at the reflection spectrum of the Bragg grating.

2. The laser assembly of claim 1, wherein the core of the double-clad optical fiber supports at least single mode transmission at the wavelength of the multimode laser.

3. The laser assembly of claim 1 or 2, wherein the Bragg grating has a reflectivity of at least 10%.

4. A method of stabilizing a multimode laser, the multimode laser having a gain spectrum, at least one output and operating at a given wavelength, the method comprising:
providing a double-clad step index optical fiber having a free end coupled to the output of the multimode laser, the double-clad optical fiber having a core, a multimode inner cladding surrounding the core, and an outer cladding surrounding the inner cladding, the outer cladding being provided to contain light in the inner cladding; and
positioning the free end of the double-clad optical fiber so that some of the light emitted by the multimode laser enters the core thereof while most of the remainder enters the inner cladding;
wherein the improvement comprises:
providing a fiber Bragg grating written in the core of the double-clad optical fiber at a given distance from the free end thereof, the Bragg grating having a reflection spectrum within the gain spectrum of the multimode laser;
whereby, in use, light emitted at the output of the multimode laser traveling in the core is reflected backwards by the Bragg grating and reenters into the multimode laser through the output so as to generate a sufficient feedback to stabilize it at the reflection spectrum of the Bragg grating.

5. The method of claim 4, wherein the core of the double-clad optical fiber supports at least single mode transmission at the wavelength of the multimode laser, the free end of the double-clad optical fiber being positioned so that light enters the core substantially at a normal incidence.

6. The method of claim 4 or 5, wherein the Bragg grating has a reflectivity of at least 10%.
